(19) United States
(12) Patent Application Publication
(10) Pub. No.: US 2004/0095985 A1
(43) Pub. Date: May 20, 2004

(54) Dual-use infrared thermometer

(76) Inventors: Kun Yuan Ko, Chubei City (TW); Tao Cheng Lu, Chubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/638,349

(22) Filed: Aug. 12, 2003

(30) Foreign Application Priority Data
Nov. 15, 2002 (TW) 91218402

(51) Int. Cl. G01K 1/00

(52) U.S. Cl. 374/100; 374/1; 374/208; 374/121

(57) ABSTRACT

The invention provides a dual-use infrared thermometer, including a main body and a probe, wherein the probe is formed at the top end of the main body; a hollow sleeve, whose shape is corresponding to the probe to be sleeved onto the probe for forming a forehead-type probe; and a temperature detection device, provided inside the main body to sense the infrared emissions and then convert the emissions into electronic signal, while a build-in temperature calibration procedure is employed to calculate the measured temperature. Alternatively,an interface switch device is provided on the surface of the probe, extending to the internal of the main body to be electrically connected to the temperature detection device. Thus, by detecting whether the hollow sleeve has been sleeved on the probe, the temperature detection device will be activated to switch to either the ear temperature calibration procedure or the forehead temperature calibration procedure. Therefore, the invention has dual functions of ear temperature measurement and forehead (or temporal) temperature measurement to achieve a double check effect and can be low in cost, simple for operation and easy for using.

### BACKGROUND OF THE INVENTION

1. Field of the Invention

The invention relates to an improved structure of infrared thermometer and, more particularly, to a dual-use infrared thermometer having two functions of ear temperature measurement and forehead (or temporal) temperature measurement.

2. Description of the Related Art

In recent years, ear thermometers have become a necessity in families for temperature measurement and have been widely used in clinics and hospitals as well. The reason to take ear temperatures is that the tympanic membrane is located inside the skull close to the pituitary gland, which is a thermoregulatory center, and the tympanic membrane is near the neck artery that has sufficient bloodstream. Therefore, if the core temperature of a human body has a change, the temperature of tympanic membrane can tell the difference. Moreover, being located inside the ear canal instead of being exposed in an external environment, the tympanic membrane is not likely to be affected by the ambient temperature. Hence, from a medical point of view, ear temperature is considered to be the most reliable temperature and the nearest to the body's central temperature.

In spite of the above-mentioned benefits, an ear thermometer still has its insufficiency and uncertainty when used for temperature measurement. The insufficiency of an ear thermometer is that its temperature is obtained through the sensor of the ear thermometer that receives infrared emission from the tympanic membrane; that is, the sensor of the ear thermometer does not have a direct contact with the tympanic membrane. In other words, this kind of measurement is a non-contact style and thus prone to have temperature differences. On the other hand, the uncertainty of an ear thermometer is that the derived temperature can only be sure about its accuracy when the sensor is aiming at the tympanic membrane, but, unfortunately, the sensor might fail to do so because a person's ear canal is not straight enough to guarantee a non-missing temperature detecting. In fact, it is possible that the obtained temperature is detected from the muscle of the ear canal rather than the tympanic membrane.

Aside from an ear thermometer, touching a patient's forehead has been a quick way for feeling a patient's temperature when the patient is having a fever. Inspired by this method, other kinds of thermometers have been developed based on the forehead or temporal temperature measurement, which utilize infrared to take temperatures from the surface of head rather than the ear canal. In the past two years, FDA (Food and Drug Administration) of the United States has authorized several kinds of infrared thermometers other than the ear thermometers, including the infrared forehead thermometer and the infrared temporal artery thermometer. The temperature measurement theory applied by the two thermometers is the same as that of applied by the ear thermometer, which is taking temperature from a person's head surface through infrared emissions from the person. Theoretically, such forehead temperature is capable of meeting the medical requirement for an accurate temperature (i.e., the temperature difference is between ±0.2 degrees Celsius). However, the surface temperature of head may change due to sweating or influenced by ambient. Therefore, the obtained temperature cannot guarantee to be the real temperature in the internal body.

In viewing the aforementioned problems, the invention provides a dual-use infrared thermometer that can be used for both forehead and ear temperature measurements. Through double confirmations made by the forehead and ear measurements, the measured temperature can be reassured for its accuracy, and the possibility of misjudgment can be reduced, thereby resolving the problems caused by the conventional ear thermometers and forehead thermometers.

### SUMMARY OF THE INVENTION

The main and first object of the invention is to provide a dual-use infrared thermometer capable of measuring the ear temperature and the forehead (or temporal) temperature, providing dual functions to its users for selection, and having an effect of double confirmations to ensure accuracy of the measured temperature and thus resolve the problem of high misjudging rate caused by the conventional thermometers.

The second object of the invention is to provide a dual-use infrared thermometer that is simple to be operated and easy to be used, which means that a forehead-type hollow sleeve is the only thing required to be sleeved onto the probe of the thermometer, and then the temperature calibration procedure inside the thermometer can be automatically switched and functions as an infrared forehead thermometer. The fourth object of the invention is to provide a simple structured dual-use infrared thermometer that has low cost and low price.

According to the invention, a dual-use infrared thermometer includes a main body, which is narrower at its top end to form a probe; a hollow sleeve to be provided to sleeve the probe, wherein the shape of the hollow sleeve is corresponding to that of the probe; and a temperature detection device set inside the main body to detect the infrared emissions guided-in by the probe, convert the emissions into electronic signals, and then calculate the needed temperature according to the electronic signals by means of a build-in temperature calibration procedure.

An interface switch device is also set on the surface of the probe, extending to the internal of the main body to be connected to the temperature detection device so as to detect whether the hollow sleeve has sleeved the probe and then to determine whether the ear temperature calibration procedure or the forehead temperature calibration procedure should be activated according to the detected result.

The objects and technical contents of the invention will be better understood through the description of the following embodiments with reference to the drawings.

### BRIEF DESCRIPTION OF THE DRAWINGS

FIG. 1 is a perspective schematic diagram showing the structure of the invention.

FIG. 2 is a perspective schematic diagram showing the structure of the invention being viewed from another direction.

FIG. 3 is a block schematic diagram showing the structure of the temperature detection device of the invention.

FIG. 4 is a perspective schematic diagram showing the structure of the invention after it has been sleeved with the hollow sleeve.

### DETAILED DESCRIPTION OF THE PREFERRED EMBODIMENTS

The invention provides a forehead-type hollow sleeve to be sleeved onto the probe of the infrared thermometer, and a switch is also set on the surface of the probe to sense whether the hollow sleeve is onto the probe and, if so, to automatically activate the temperature calibration procedure so that the users can have a choice of two functions and can double confirm the measured temperature.

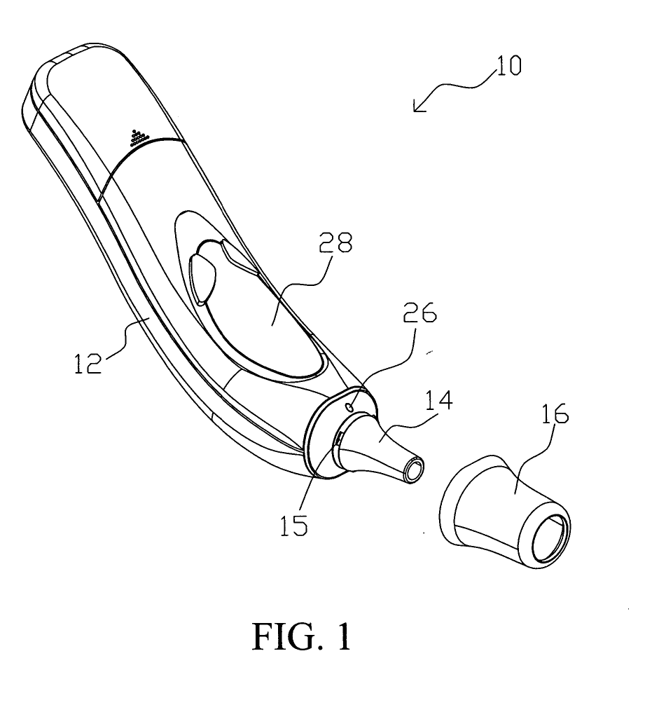

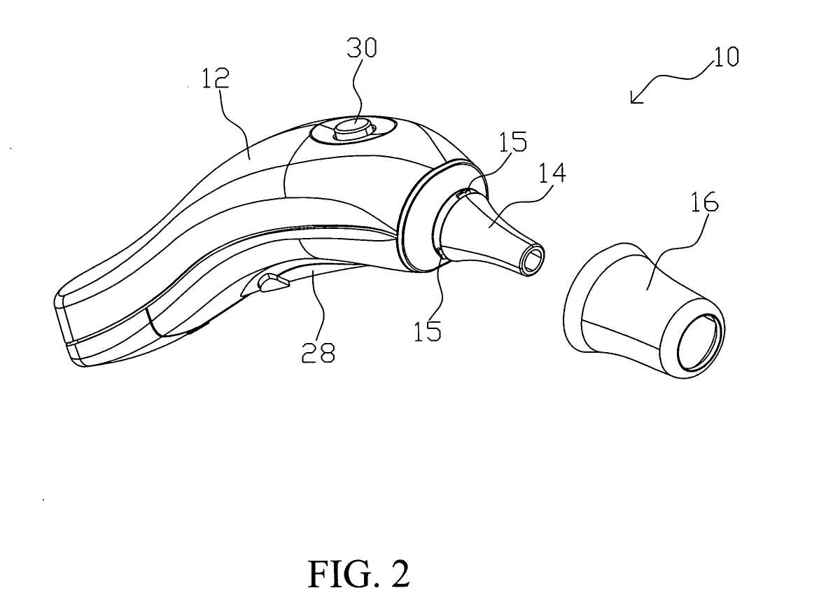

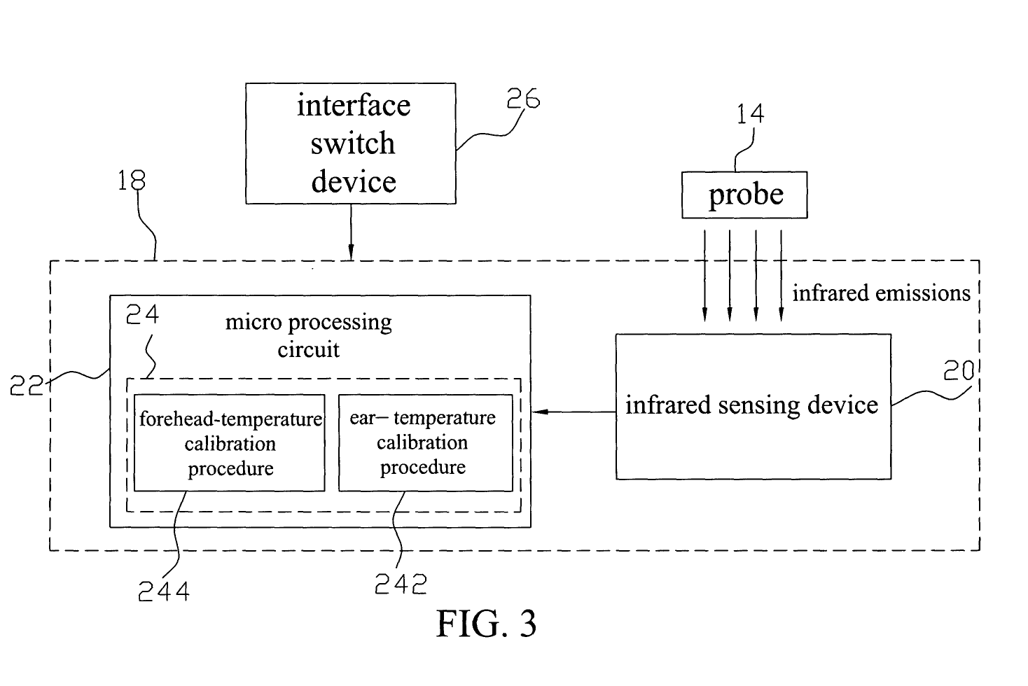

FIGS. 1 and 2 are perspective schematic diagrams showing the structure of the invention viewed from two different directions. As shown in FIGS. 1 and 2, a dual-use infrared thermometer 10 includes a main body 12, which is narrower at its top end to form a probe 14, and the probe 14 is provided with a hollow sleeve 16. Besides, three lodge-in openings 15 and three protrusions (not shown) are set on the surface of the probe 14 at the inner wall of the hollow sleeve 16 to facilitate the hollow sleeve 16 to sleeve the probe 14 and inset into the lodge-in openings 15 for fastening and thus complete the forehead-type probe. However, it is not a must for the hollow sleeve 16 to be sleeved onto the probe 14; it is only an alternative to do so. Moreover, a temperature detection device 18 (not shown) is set inside the main body 12. The structure of the temperature detection device 18 is as shown in FIG. 3, which includes an infrared sensing device 20 and a micro processing circuit 22, wherein a temperature calibration procedure 24 is built in the micro processing circuit 22. The micro processing circuit 22 includes an ear temperature calibration procedure 242 and a forehead temperature calibration procedure 244. To obtain a measured temperature, the following steps will be gone through. First, the infrared emissions are detected by the infrared sensing device 20 and then are guided into the main body 12 through the probe 14. Next, the infrared emissions will be converted into electronic signals and then transmitted to the micro processing circuit 22. Afterwards, the micro processing circuit 22 will employ the build-in temperature calibration procedure 24 and calculate the desired temperature according to the electronic signals.

Also, referring to FIGS. 1 and 2, an interface switch device 26 is set on the surface of the probe 14 extending to the internal of the main body 12 to be connected to the micro processing circuit 22 inside the temperature detection device 18. The interface switch device 26 is normally a switch or a sensor to detect whether the hollow sleeve 16 has sleeved the probe 14 and, if so, to activate the micro processing circuit 22 for switching on the temperature calibration procedure 24.

In addition, a display module 28 and a pushbutton switch 30 are set on the surface of the main body 12, extending separately to the internal of the main body 12 to be electrically connected to the micro processing circuit 22. When the pushbutton switch 30 is pressed, the measuring procedure will be activated, and then the calculated temperature done by the micro processing circuit 22 will be displayed on the display module 28.

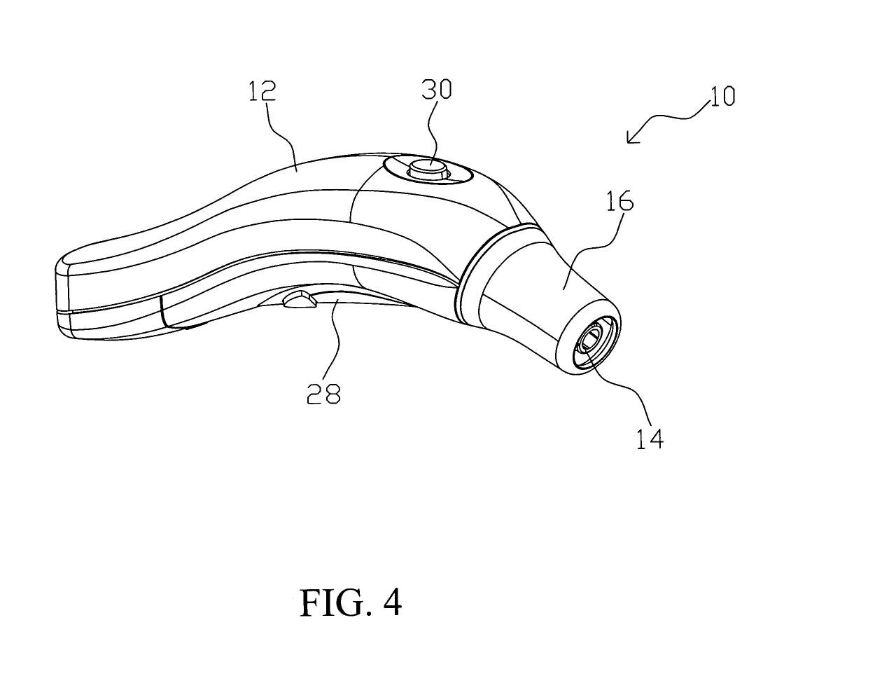

To illustrate how the interface switch device 26 activates the micro processing circuit 22 for switching on the temperature calibration procedure, the following description will treat an interface switch device 26 as a switch. When a user wants to apply a forehead-type measuring function to measure temperature on the forehead or the temple, the user only has to sleeve the hollow sleeve 16 onto the probe 14, as shown in FIG. 4. Then, the interface switch device 26 will be conducted to the micro processing circuit 22, and the micro processing circuit 22 will be activated and automatically switch to the forehead temperature calibration procedure 244 and use it as the temperature calibration procedure 24, and then the measured temperature will be calculated accordingly.

On the other hand, when a user wants to measure an ear temperature, the user only has to take the hollow sleeve 16 away from the probe 14. By doing so, there will not be a conduction between the interface switch device 26 and the micro processing circuit 22, which means the temperature calibration procedure 24 is still staying on the preset ear temperature calibration procedure 242. Therefore, when the user inserts the probe 14 into the desired ear canal and pushes the pushbutton switch 30, the micro processing circuit 22 will calculate the measured temperature according to the ear temperature calibration procedure 242.

Alternatively, the shape of the hollow sleeve 16 can be differently designed to suit for different needs. If the hollow sleeve 16 is so designed that after it has sleeved the probe 14, it will fall within the field of view of the infrared sensing device 20, then the infrared sensing device 20 will receive the infrared emissions radiated by the hollow sleeve 16 and thus affect the measured result. Therefore, the temperature calibration procedure 24 will include the ear temperature calibration procedure 242 and the forehead temperature calibration procedure 244. Consequently, the interface switch device 26 will be used to detect whether the hollow sleeve 26 has sleeved the probe 16 and, if so, will automatically switch on the temperature calibration procedure 24.

In conclusion, the invention makes it possible that the infrared thermometer have dual functions to measure ear temperature and forehead (or temporal) temperature and thus achieve the effect of double confirmations so as to cope with the conventional problem of high misjudging rate of the measured temperature. Above all, as soon as the hollow sleeve is sleeved onto the probe of the thermometer, the measuring mode can be either automatically switched or stay on the same mode for temperature measurement. Therefore, the effect of double use and double check can be achieved by a simple operation. Moreover, the invention can achieve the dual-use function without changing much on the structure of a conventional ear thermometer. Hence, the invention actually owns the advantages of simple structure, low cost, and low price.

The embodiments above are only intended to illustrate the invention; they do not, however, to limit the invention to the specific embodiments. Accordingly, various modifications and changes may be made without departing from the spirit and scope of the invention as described in the appended claims.

What is claimed is:

1. A dual-use infrared thermometer, for measuring the forehead (or temporal) temperature and the ear temperature, including:
a main body, which is narrower at its top end to form a probe;
a temperature detection device, set inside the main body to sense the infrared emissions guided-in by the probe and convert the infrared emissions into electronic signals, and then the measured temperature will be calculated by means of the build-in temperature calibration procedure according to the electronic signals;
a hollow sleeve, provided to sleeve the probe; and
an interface switch device, set on the surface of the probe extending to the internal of the main body to be electrically connected to the temperature detection device so that the hollow sleeve can be detected whether it has been sleeved on the probe and, if so, the temperature detection device will be activated for switching the temperature calibration procedure.

2. The dual-use infrared thermometer as claimed in claim 1, wherein the temperature detection device includes an infrared sensing device and a micro processing circuit.

3. The dual-use infrared thermometer as claimed in claim 1, wherein the interface switch device is selected from either a switch or a sensor.

4. The dual-use infrared thermometer as claimed in claim 2, wherein the temperature calibration procedure is built in the micro processing circuit, including an ear temperature calibration procedure and a forehead temperature calibration procedure.

5. The dual-use infrared thermometer as claimed in claim 4, wherein if the interface switch device has detected that the hollow sleeve does not sleeve the probe, the temperature detection device will calculate the measured temperature according to the ear temperature calibration procedure.

6. The dual-use infrared thermometer as claimed in claim 4, wherein if the hollow sleeve sleeves the probe, the interface switch device will conduct the temperature detection device, and the temperature detection device will be activated so that the temperature calibration procedure can be switched to its forehead temperature calibration procedure, and the measured temperature can be calculated accordingly.

7. The dual-use infrared thermometer as claimed in claim 1, wherein a display module is set on the surface of the main body, extending to the internal of the main body to be electrically connected to the temperature detection device.

8. The dual-use infrared thermometer as claimed in claim 1, wherein a pushbutton switch is set on the surface of the main body, extending to the internal of the main body to be electrically connected to the temperature detection device.

9. A dual-use infrared thermometer, for measuring the forehead (or temporal) temperature and the ear temperature, including:
a main body, which is narrower at its top end to form a probe;
a temperature detection device, set inside the main body to sense the infrared emissions guided-in by the probe and convert the infrared emissions into electronic signals, and then the measured temperature will be calculated by means of the build-in temperature calibration procedure according to the electronic signals; and
a hollow sleeve, wherein its shape is corresponding to the shape of the probe so as to be provided to sleeve the probe, and after the hollow sleeve has sleeved the probe, the hollow sleeve will be out of view of the infrared detecting field of the temperature detection device.

10. The dual-use infrared thermometer as claimed in claim 9, wherein the temperature detection device includes an infrared sensing device and a micro processing circuit.

11. The dual-use infrared thermometer as claimed in claim 10, wherein the temperature calibration procedure is built in the micro processing circuit.

12. The dual-use infrared thermometer as claimed in claim 9, wherein a display module is further set on the surface of the main body, extending to the internal of the main body to be electrically connected to the temperature detection device.
